(19) United States
(12) Patent Application Publication
(10) Pub. No.: US 2010/0021622 A1
(43) Pub. Date: Jan. 28, 2010

(54) Apparatus and method for forming multilayer polymer thin film

(75) Inventors: Hsin-Fei Meng, Hsinchu (TW); Sheng-Fu Horng, Hsinchu (TW); Hsin-Rong Tseng, Hsinchu (TW); Chi-Shen Tuan, Jhubei City (TW)

Correspondence Address: BACON & THOMAS, PLLC, 625 SLATERS LANE, FOURTH FLOOR, ALEXANDRIA, VA, 22314-1176, US

(73) Assignee: National Chiao Tung University, Hsinchu (TW)

(21) Appl. No.: 12/219,554

(22) Filed: Jul. 24, 2008

(51) Int. Cl. B05D 5/12

(52) U.S. Cl. 427/66; 118/58

(57) ABSTRACT

Apparatus and method for forming multilayer polymer thin film. The method uses a solution container with a gap to prevent the huge amount of solution from directly falling on the first layer. Then the wet film is formed by moving the container with the thin film thickness is decided by the distance between the gap and the substrate. The wet film is dried in a very short time by the heater therefore there is no time for the second solvent to dissolve the first layer. The method can effectively achieve the large-area and multilayer structure in organic devices through solution processing.

### BACKGROUND OF THE INVENTION

1. Field of the Invention

The present invention relates to a solution processing technology, particularly to an apparatus and method for forming multilayer polymer thin film.

2. Description of the Prior Art

According to molecular size of raw material, the organic optoelectronics can be divided into the organic optoelectronics made by solution process and the organic optoelectronics made by evaporation process.

Although, it is known that the evaporation process can be used to make the organic optoelectronics with multilayer structure easily, this process is not suitable to make the large-area organic optoelectronics.

Relatively, the solution processing is simpler and cheaper than the evaporation process for making the organic optoelectronics, thus it is suitable to make the large-area organic optoelectronics and devices. However, there is a serious mutual dissolution problem among layers upon making multilayer components by solution process. For example, the solvent of the second layer might dissolve and destroy the first layer, and cause the mutual dissolution problem.

In order to respond the requirement for the solution processing technology of the organic optoelectronics, it is still necessary to develop the relevant technology to save the cost, such as manpower and time etc.

### SUMMARY OF THE INVENTION

The purpose of the present invention is to provide an apparatus and a method for forming multilayer polymer thin film, in order to make the multilayer organic optoelectronics, especially for the organic photo-electric transforming device including the organic light-emitting diode, the organic photovoltaic cell, the organic photo-detector and the organic transistors.

Another purpose of the present invention is to provide an apparatus and method for making a multilayer device structure with solution process and solution casting device thereof, in order to solve the mutual dissolution problem among layers effectively upon making multilayer organic optoelectronics.

According to a feature of the present invention, provide an apparatus and method for making a multilayer device structure with solution process. Upon implementing, a solution container with a gap can be used.

The above-mentioned organic molecular container can be used to contain the organic molecular solution. The above-mentioned method normally comprises: providing a substrate; making an organic molecular film on the substrate; using the gap of the organic molecular container to control the amount of organic molecular solution fallen on the organic molecular film, in order to form a wet film of organic molecular. This method can also use a blade device (such as the blade coating equipment) to determine the thickness of organic molecular wet film.

In addition, this method uses an accelerating means to accelerate the speed of solvent evaporation in the organic molecular wet film, in order to prevent the original organic molecular film downwards from re-dissolving, wherein this accelerating means might be the heating way.

According to a feature of the present invention, a solution casting device is provided. The above-mentioned solution casting device is used to form at least a film on the substrate of the organic optoelectronics, wherein the organic optoelectronics might be thin film organic light-emitting devices, organic transistors, organic solar cells, or organic photo-detectors.

The above-mentioned solution casting device includes the organic molecular container, inlet valves, and heaters. The above-mentioned organic molecular container is used to contain the organic molecular solution. And the organic molecular container has a gap facing to the substrate. The distance between the container and the substrate is controlled by a machine. The wet film thickness is decided by the distance between the gap and the substrate, which determines dry film thickness. The above-mentioned inlet valve is placed on the organic molecular container, in order to control the amount of organic molecular solution flowing out through the gap.

In an embodiment of the present invention, the organic molecular container includes a top cover, which has an air vent, and the above-mentioned inlet valve is placed on the air vent of top cover.

In an embodiment of the present invention, the organic molecular container includes a motor, in order to control the movement of the organic molecular container.

In an embodiment of the present invention, the above-mentioned solution casting device includes a heater, in order to accelerate the evaporation of solvent in the wet film and the forming speed of thin film.

In an embodiment of the present invention, the distance between the gap and the substrate in the organic molecular container is adjustable, and the thin film thickness on the substrate is decided by this distance.

The advantage and spirit of the present invention can be further understood by the following detailed description and attached figures.

### BRIEF DESCRIPTION OF THE DRAWINGS

FIG. 1 shows the schematic diagram of a preferred embodiment of the organic molecular container of the present invention.

FIG. 2 shows the schematic assembled diagram of a preferred embodiment of the organic molecular container of the present invention.

FIG. 3 shows the flow diagram of a preferred embodiment of the present invention for making a multilayer device structure with solution process.

FIG. 4 shows the schematic diagram of a preferred embodiment of the present invention for making a multilayer device structure.

FIG. 5 shows the side view of a preferred embodiment of the present invention to make the multilayer thin film.

FIG. 6a shows the current efficiency-voltage diagram of single layer devices made by the preferred embodiment of the present invention.

FIG. 6b shows the luminance-voltage diagram of single layer devices made by the preferred embodiment of the present invention.

FIG. 7a shows the current efficiency-voltage diagram of double layer devices made by the preferred embodiment of the present invention.

FIG. 7b shows the luminance-voltage diagram of double layer devices made by the preferred embodiment of the present invention.

FIG. 8 shows the results of organic solar cells made by the invention.

### DESCRIPTION OF THE PREFERRED EMBODIMENT

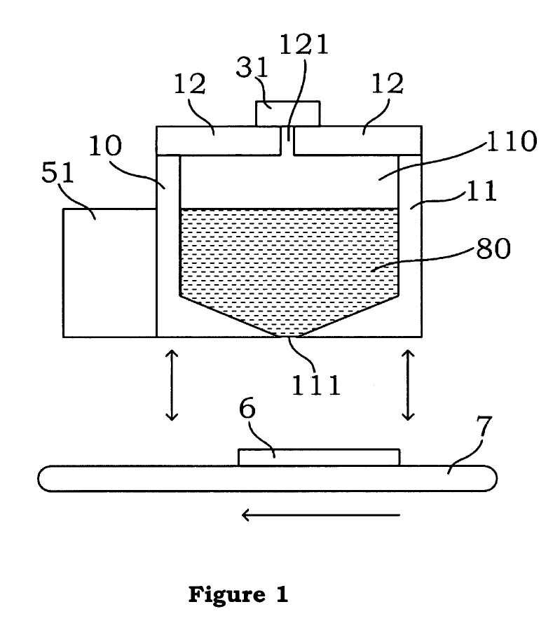

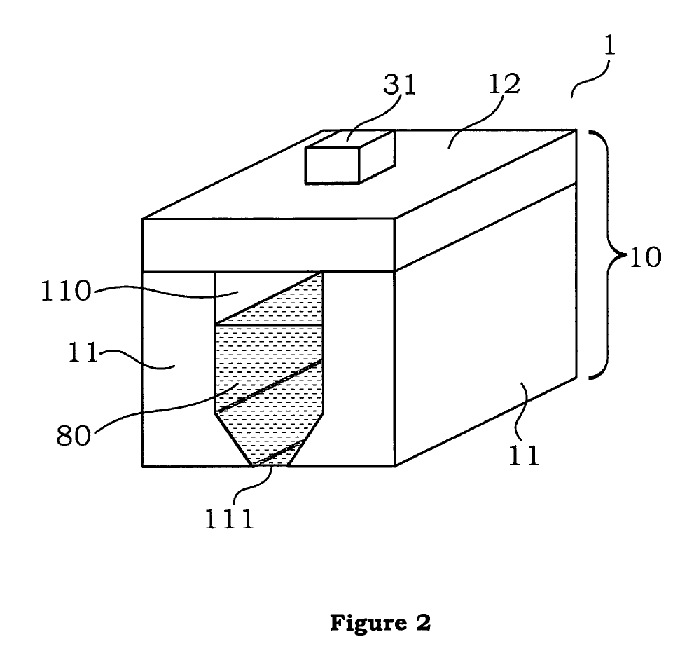

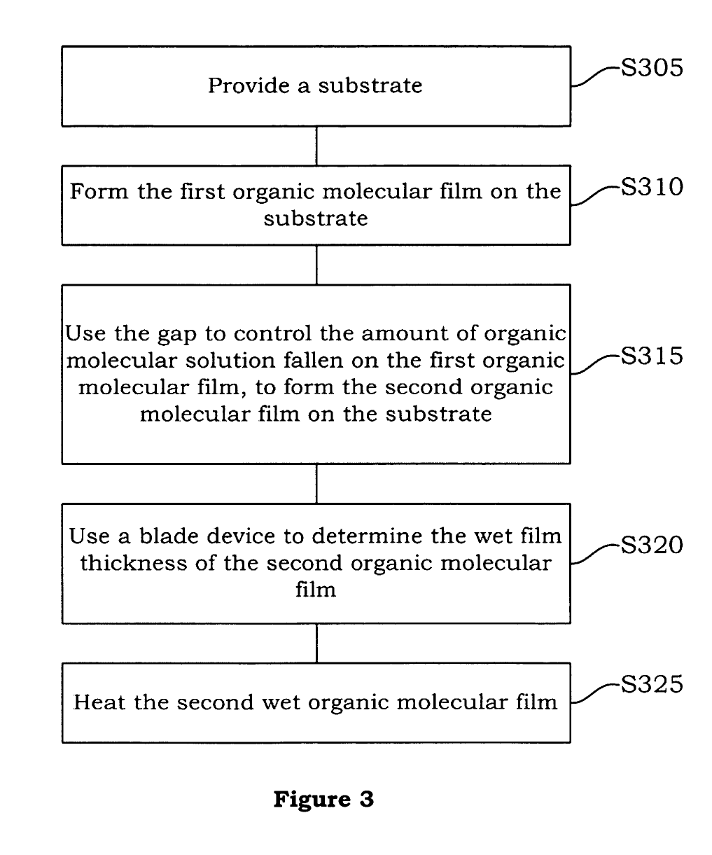

The present invention relates to an apparatus and method for forming multiplayer polymer thin film, especially the multiplayer polymer thin film being applied for the organic photo-electric transforming device including the organic light-emitting diode, the organic photovoltaic cell, the organic photo-detector, and the organic transistors. Referring to FIG. 1, FIG. 2, and FIG. 3 are illustrated for the description of the embodiments of the present invention.

FIG. 1 shows the side view of an embodiment of the solution casting device of the present invention. In this embodiment, the solution casting device comprises the organic molecular container 10, inlet valve 31, and a heater 51. The organic molecular container 10 includes the shell body 11 and top cover 12. The shell body 11 has a containing space 110 and gap 111. Top cover 12 has an air vent 121.

FIG. 2 shows the schematic diagram of an embodiment of the organic molecular container of the present invention. The inlet valve 31 is placed on the air vent 121 of top cover 12 of organic molecular container 10 as shown in FIG. 1. The air stream provided by inlet valve 31 can enter the containing space 110 of shell body 11 through air vent 121, in order to control the amount of organic molecular solution 80 flowing out through gap 111.

The solution casting device of the present invention is used to form at least a film on the substrate 6 of the organic optoelectronics, wherein the organic optoelectronics might be thin organic light-emitting devices, organic transistors, organic solar cells, or organic photo-detectors.

In this embodiment, the distance between the gap 111 and the substrate 6 in the organic molecular container 10 is adjustable, and the film thickness on the substrate 6 is decided by this distance.

In this embodiment, the organic molecular container 10 is placed on the adjustment equipment (not shown in the figure). The adjustment equipment can be used to control the distance between the organic molecular container 10 and the substrate 6. In addition, the adjusting equipment can be coupled with at least a motor (not shown in the figure). The operation of adjusting equipment can be controlled by the motor, in order to control the distance between the organic molecular container 10 and the substrate 6. In this embodiment, the adjusting equipment can be a machine tool, sliding rail, or mechanical means such as mechanical arm.

In this embodiment, the heater 51 is set at one side of the organic molecular container 10, in order to accelerate the forming speed of thin film on the substrate 6. In the other embodiment, the heater 51 can also be set at the base, such the bottom substrate 6, in order to accelerate the forming speed of thin film.

FIG. 3 shows the flow diagram of an embodiment of the present invention for making a multilayer device structure with solution process.

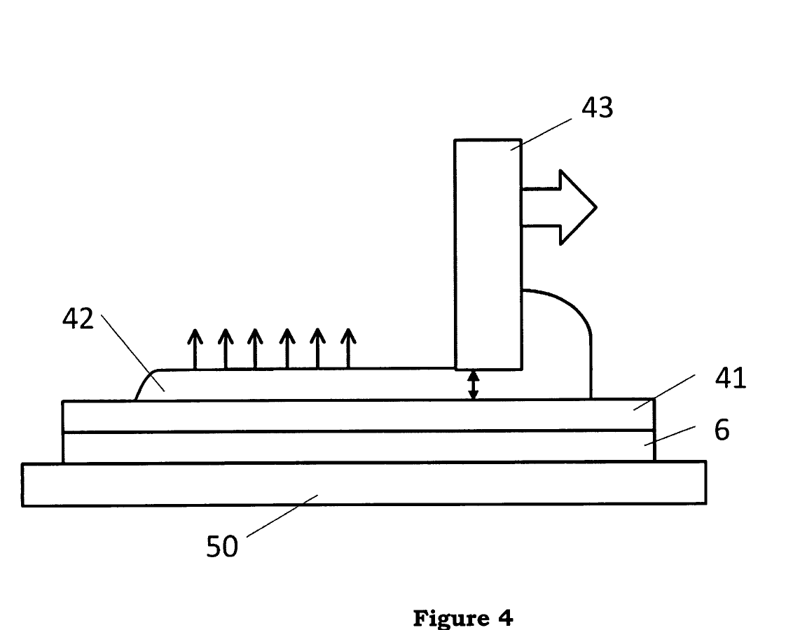

FIG. 4 shows the schematic diagram for making a multilayer device structure. Please refer to FIG. 1 to FIG. 4 for the description of making a multilayer device structure.

In step S305, a substrate 6 is provided, a multilayer thin film is formed on this substrate 6. In this embodiment, the substrate 6 is placed on the belt conveyor 7, wherein the transfer direction of belt conveyor 7 is from right to left. In the other embodiment, the substrate 6 can be placed on a fixed position, and the organic molecular container 10 is placed on the belt conveyor 7 or the sliding rail. In this embodiment, the substrate 6 is the indium tin oxides (ITO) transparent conductive coating.

In step S310, the flow of the organic molecular solution 80 through the gap 111 is controlled, in order to form the first layer of organic molecular thin film 41 on the substrate 6. And the heater 51 is used to accelerate the drying to form the first layer of organic molecular thin film 41.

In step S315, the gap 111 of organic molecular container 10 is used to control the amount (that is thickness) of organic molecular solution 80 fallen on the first layer of organic molecular thin film 41 as dry thin film, in order to form the second layer of wet organic molecular thin film 42.

In step S320, a blade device 43 is used to determine the thickness of the second layer of wet organic molecular thin film 42.

In step S325, a heater 51 is used to heat the second layer of wet organic molecular thin film 42, in order to accelerate the evaporation speed of solvent in the second layer of wet organic molecular thin film 42, so that the second layer of wet organic molecular thin film 42 can become a dry thin film.

The thickness of the second layer of wet organic molecular thin film 42 can be controlled by the distance between the blade and the substrate. In addition, the embodiment of the present invention uses the heating means to evaporate the solvent in the second layer of wet organic molecular thin film 42 quickly, to prevent the formed organic molecular film (the first layer of organic molecular thin film 41) from re-dissolving.

In addition, the solvent casting device 1 provided by this embodiment can use the inlet valve 31 to adjust the falling speed of solution for forming the wet thin film, thus it can make the multilayer organic optoelectronics effectively. Furthermore, if the length of gap is adjusted, this device can make large-area structure effectively. Unlike the conventional spin coating method, the usage of material can be more than 90% by the invention.

Notice that only an organic molecular container is used to make film in this embodiment. In the other embodiment, several organic molecular containers can be used to make films. In addition, in this embodiment, the organic molecular container has a gap. In the other embodiment, each organic molecular container can have several gaps.

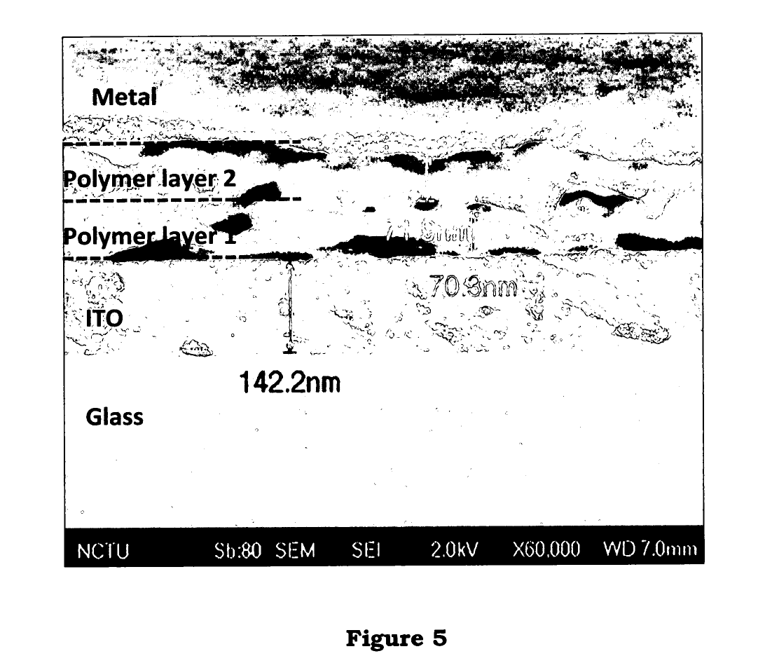

FIG. 5 shows the lateral profile of double layer polymer film by scanning electron microscope (SEM), which can verify the feasibility (making the multilayer thin film) of this method.

Then, the Keithley 2400 Current Source Meter is used to measure the voltage-current characteristics of a single film of the multilayer organic optoelectronics made by the solution casting device in this embodiment. The PR650 is used to measure the optical characteristics, such as the spectrum, luminance, light emitting efficiency, and CIE coordinate etc. Meantime, the computer program is combined with the Keithley 2400 Current Source Meter and PR650 to measure the electrical and optical properties of the organic optoelectronics.

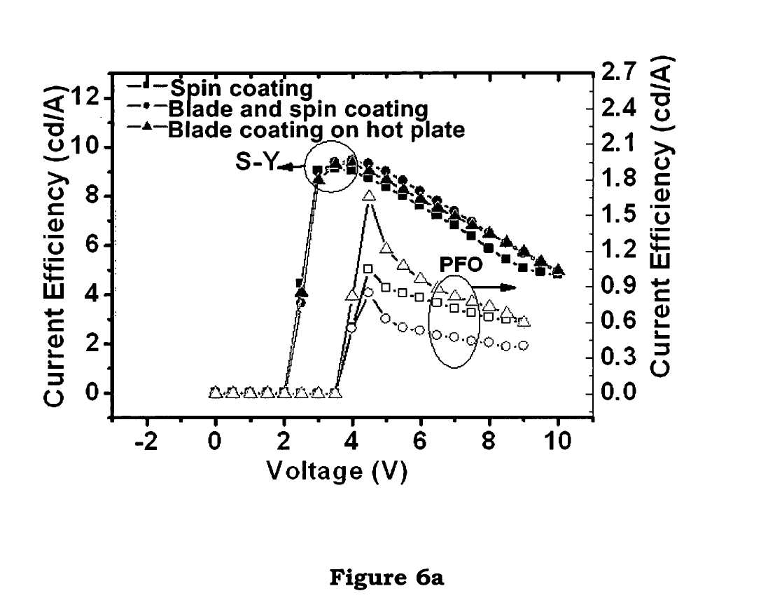

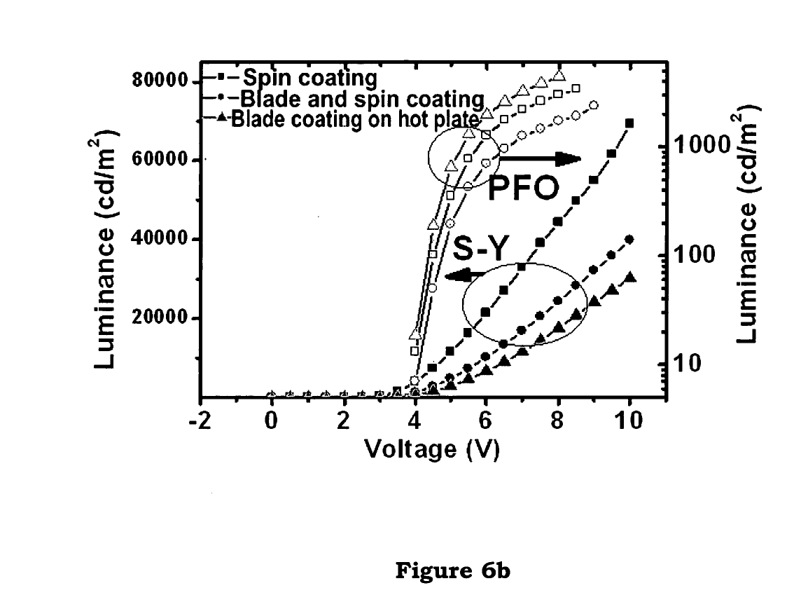

The experimental results are shown in FIG. 6a and FIG. 6b. From the light emitting efficiency-voltage curves, luminance-voltage diagrams, it is shown that the single layer devices made by this embodiment is similar to those made by common spin coating process.

In addition, the Keithley 2400 Current Source Meter is used to measure the voltage-current characteristics of double-layer organic optoelectronics made by the solution casting device in this embodiment. The PR650 is used to measure the optical characteristics, such as the spectrum, luminance, light emitting efficiency, and CIE coordinate etc. Meantime, the computer program is combined with the Keithley 2400 Current Source Meter and PR650 to measure the electrical and optical properties of double-layer organic optoelectronics.

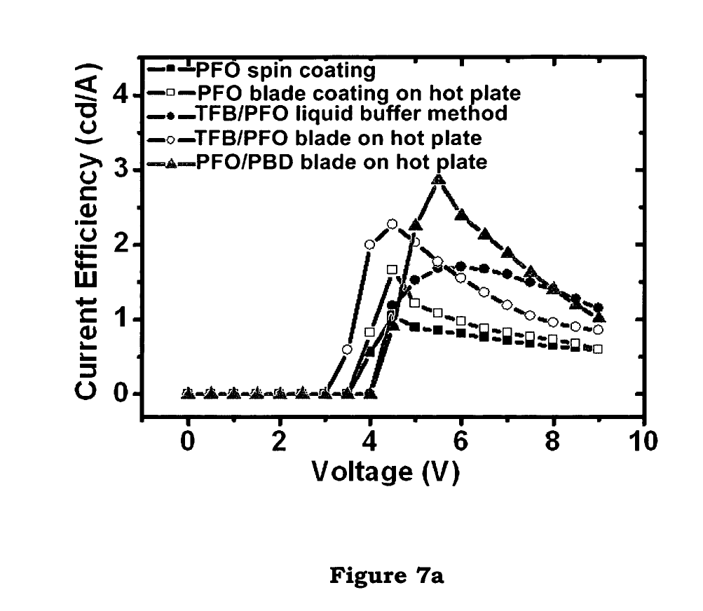

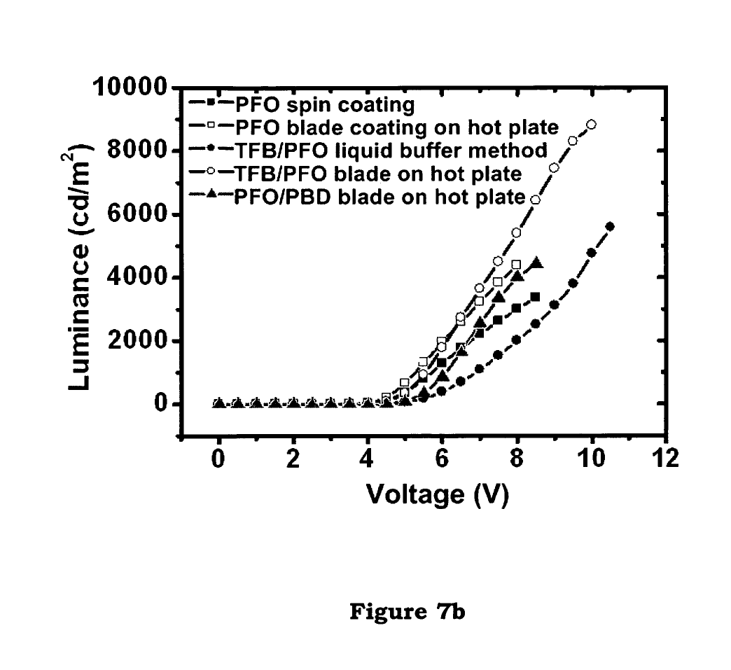

The optoelectronic properties are shown in FIG. 7a and FIG. 7b. From the experimental results of FIG. 7a and FIG. 7b, it is shown that the double-layer devices made by the embodiment will be better than those made by common spin coating process.

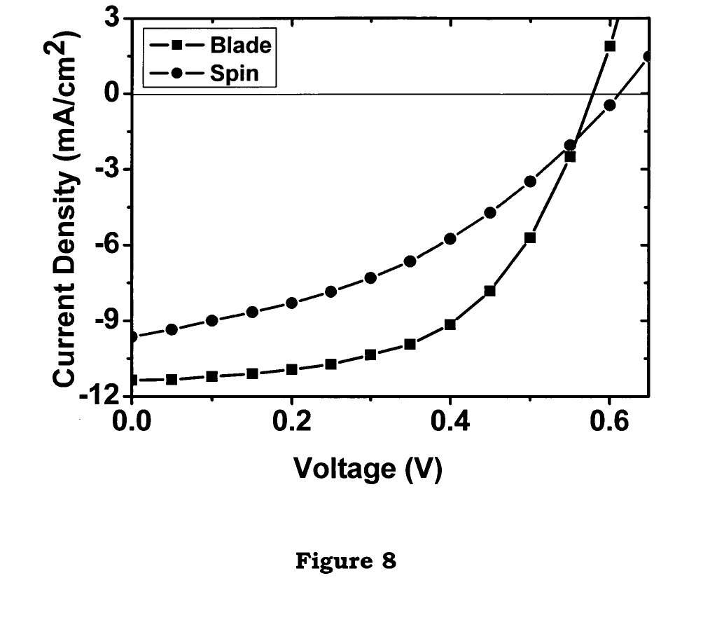

Obviously, FIG. 8 and Table 1 show the results of organic solar cells made by the invention and spin coater. As the result can be obtained, the power conversion efficiency of the solar cell by the invention will be better than the solar cell by the conventional spin coating process.

TABLE 1

Manufacturing
Method

| Testing Factor | Blade | Spin |
|---|---|---|
| Short-circuit current density (mA/cm²) | 11.36 | 9.63 |
| Open-circuit voltage (V) | 0.58 | 0.61 |
| Fill Factor (%) | 55 | 39 |
| Power conversion efficiency (%) | 3.66 | 2.32 |

From the above-mentioned explanation, it is known that the preferred embodiment of this invention uses a solution container with a gap to prevent the huge amount of solution from directly falling on the first layer. A similar blade technology is used to determine the wet film thickness, and a heating device is used to bake the wet film to form the dry film. This can solve the mutual dissolution problem among layers effectively upon making multilayer organic optoelectronics.

It is understood that various other various modifications will be apparent to and can be readily made by those skilled skills in the art without departing from the scope and spirit of this invention. Accordingly, it is not intended that the scope of the appended claims appended hereto be is limited to the description as set forth herein, but rather that the claims be construed as encompassing all the features of patentable novelty that which resides in the present invention, including all features that would be treated as equivalents thereof by those skilled skills in the art to which this invention pertains.

What is claimed is:

1. A method for forming multiplayer polymer thin films, comprising:
providing a substrate;
using a gap of an organic molecular container to control an amount of organic molecular solution fallen on an organic molecular thin film, in order to form a wet thin film with certain thickness;
using a heating way to accelerate the wet thin film to form the dry thin film, in order to prevent the previous dry organic molecular thin film from re-dissolving; and
repeating a plurality of formation of wet thin film and repeating of drying of the wet thin film by using the heating way to form the multilayer organic molecular thin film.

2. The method for forming multilayer polymer thin film according to claim 1, wherein the multiplayer polymer thin film is applied for the organic photo-electric transforming device.

3. The method for forming multilayer polymer thin film according to claim 2, wherein the organic photo-electric transforming device comprises an organic light-emitting diode.

4. The method for forming multilayer polymer thin film according to claim 2, wherein the organic photo-electric transforming device comprises an organic photovoltaic cell.

5. The method for forming multilayer polymer thin film according to claim 2, wherein the organic photo-electric transforming device comprises an organic photo-detector.

6. The method for forming multilayer polymer thin film according to claim 2, wherein the organic photo-electric transforming device comprises an organic transistor.

7. The method according to claim 1, wherein the using gap of the organic molecular container used to control the amount of organic molecular solution fallen on the substrate, further comprises using a blade device to control the thickness of the wet thin film.

8. The method according to claim 1, wherein the heating way further comprises accelerating the evaporation speed of solvent in the organic molecular wet thin film.

9. An apparatus for forming multilayer polymer thin film, comprising:
an organic molecular container for an organic molecular solution, the organic molecular container having a gap facing to a substrate, wherein the organic molecular solution passing through the gap to form an organic molecular thin film on the substrate; and
a heater being set at one side of the organic molecular container, in order to accelerate the forming speed of multilayer polymer thin film on the substrate.

10. The apparatus for forming multilayer polymer thin film according to claim 9, wherein the multiplayer polymer thin film is applied for the organic photo-electric transforming device.

11. The apparatus for forming multilayer polymer thin film according to claim 10, wherein the organic photo-electric transforming device comprises an organic light-emitting diode.

12. The apparatus for forming multilayer polymer thin film according to claim 10, wherein the organic photo-electric transforming device comprises an organic photovoltaic cell.

13. The apparatus for forming multilayer polymer thin film according to claim 10, wherein the organic photo-electric transforming device comprises an organic photo-detector.

14. The apparatus for forming multilayer polymer thin film according to claim 10, wherein the organic photo-electric transforming device comprises an organic transistor.

15. The apparatus for forming multilayer polymer thin film according to claim 9, wherein the organic molecular container is placed on an adjusting equipment to control the distance between the organic molecular container and the substrate.

16. The apparatus for forming multilayer polymer thin film according to claim 9, wherein the heater can accelerate the evaporation speed of solvent in the wet organic molecular thin film.
